(19) United States
(12) Patent Application Publication
(10) Pub. No.: US 2014/0115117 A1
(43) Pub. Date: Apr. 24, 2014

(54) WEBCASTING METHOD AND APPARATUS

(71) Applicant: Mark G. Fiedler, New York, NY (US)

(72) Inventor: Mark G. Fiedler, New York, NY (US)

(21) Appl. No.: 14/124,541

(22) PCT Filed: Jun. 8, 2012
(86) PCT No.: PCT/US12/41733

§ 371 Date: Dec. 6, 2013

Related U.S. Application Data
(60) Provisional application No. 61/494,617, filed on Jun. 8, 2011.

(51) Int. Cl. H04L 29/08

(52) U.S. Cl. CPC H04L 29/08801
USPC 709/219

(57) ABSTRACT

A webcasting method and apparatus is provided that enables webcasting at speeds much faster than playback speed. The webcasting method and apparatus caches all of the audio tracks or video clips in a webcast, both on the receiving component and on any relay servers, to decouple the playing or transmitting processes from the receiving process. The webcasting method and apparatus also permits files to be webcast in their original encoded audio or video format, without any degradation and with all in formation contained in their tags. The files can then be downloaded directly from the webcast receivers cache.

### CROSS-REFERENCE TO RELATED APPLICATIONS

This application claims priority from and the benefit of U.S. Provisional Application No. 61/494,617, entitled WEBCASTING METHOD AND APPARATUS, filed Jun. 8, 2011, which application is hereby incorporated by reference.

### BACKGROUND

The present invention relates generally to a webcasting method and apparatus and, specifically, to a webcasting method and apparatus that enables webcasting at speeds faster than playback speed.

Currently existing webcasting technology uses a webcast server that transmits a stream of content (typically audio) over the Internet from a digital player running at normal playback speed. At the receiving end, the content is received into one end of a circular buffer that is advantageously made large enough to avoid interruptions in playback (i.e., buffer underruns), and content is played from the other end of the buffer. Audio webcasts include playlists of distinct tracks in a predetermined order, each representing a distinct piece of music or similar complete segment of audio content. Alternatively, webcasts may include playlists of distinct clips of video content, or a mixture of audio tracks and video clips.

Current webcasting technology, which simultaneously transmits a playlist to a plurality of listeners, is distinct from “on-demand” streaming of playlists (whether human- or computer-generated), in which one or more tracks are transmitted to one particular listener at playback speed in real time, generally beginning at the start of a playlist—although both come under the general heading of “Internet radio” or, if incorporating video, “Internet television.”

Currently existing webcasting technology employs a webcast server that receives an input of streaming audio or video content from a digital player playing at normal playback speed, and then transmits the received content at playback speed to one or more receiving components. A receiving component may be either another player playing at the same speed as the transmitting player or another webcast server, termed a relay server, which transmits at the same speed as the transmitting player to one or more players and/or relay servers. Concatenating relay servers in this manner enables a webcast to reach an unlimited number of receiving components or players, overcoming the bandwidth limitations of any particular location.

The tracks included in a webcast playlist are generally supplied in the form of encoded files, e.g., the MP3 and Ogg Vorbis (audio) formats, which encode digital content in a compressed form using a psychoacoustic model, or in various compressed video formats, such as MPEG3 (MP3 video), AVI and WMV. The use of compressed formats enables files to incorporate tags containing not only information or metadata about a track, e.g., title, composer, performers, duration, etc., but also materials related to a track such as artwork and lyrics. As the information in the tags may be quite extensive, transmitting the tag information at playback speed could produce delays or “gaps” in the audio (or video) stream. Moreover, when a receiving component connects to a webcast, the webcast is generally somewhere in the middle of a track, which results in the receiving component receiving only that portion of the track that follows the point where the receiving component first connected. This connection process can present difficulties in transmitting metadata about tracks because (1) if metadata is transmitted at the beginning of a track, the metadata can be missed by the receiving component connecting in the middle of the track; (2) if the metadata is transmitted at the end of a track, the metadata cannot be displayed until the entire track has been received; or (3) if the metadata is transmitted from time to time in the middle of the track, the receiving component may have difficulty in differentiating between the metadata and the streamed content upon first connecting to the webcast, which would involve avoidable inefficiencies in content length and/or processing time.

To address the difficulties in sending metadata, current technology omits all information contained in the tags from the webcast transmission, and employs a separate “title stream” that repeatedly streams a limited amount of information about the current track. One track buffering method overcomes some of the metadata sending difficulties, and removes the need for a “title stream,” by supplying the receiving component, upon connecting to the webcast, with the beginning of the current track—so that any needed metadata (about either the current track or the entire playlist) may be supplied before the current track.

Another significant drawback of current webcasting technology, including “on-demand” streaming, is degradation of the audio stream. Audio files in a webcast playlist may have been encoded to play at various “bitrates,” e.g., between 24 and 128 kilobits per second, and may even be encoded in different formats. However, for various reasons having to do with the transmitting capacity of network connections and allowing streaming buffers of a fixed size, as well as the difficultly of including metadata, such as the bitrate, in the stream, but principally because a webcast server must be supplied by a player producing a waveform stream at playback speed, webcasts are transmitted in a single format at a uniform bitrate, both of which must be known in advance by the receiving components. To achieve the single format at a uniform bitrate, the encoded audio files are first decoded into a playable waveform format, then re-encoded in the desired format at the desired transmission bitrate. As the encoded formats are inherently “lossy,” the process of decoding and re-encoding inevitably compounds artifacts and other forms of degradation in the streamed content. Similar considerations apply to video files in a webcast.

Therefore, what is needed is a webcasting method and apparatus that enables webcasting at speeds much faster than playback speed in the original encoded format of the content of the webcast.

### SUMMARY

One embodiment of the present invention is directed to a system having a webcast server and a webcast client connected to the webcast server over a computer network. The webcast server includes a microprocessor and a memory device. The memory device of the webcast server stores at least one playlist in an encoded format. The webcast client includes a microprocessor and a memory device. The system also includes a webcast module being operable to facilitate the transmission of the at least one playlist from the webcast server to the webcast client without a change in the encoded format of the at least one playlist. The webcast client includes a cache to store the entire at least one playlist.

Another embodiment of the present invention is directed to a webcasting method including storing a playlist for a webcast on a webcast server by a user and selecting the playlist for download by a receiving component. The webcasting method also includes transmitting the playlist from the webcast server to the receiving component over a computer network without changing the encoded format of the playlist, storing the entire transmitted playlist in a cache of the receiving component and playing the playlist from the cache on the receiving component for a user.

The present application improves on both current webcasting methods and prior buffering methods by enabling webcasting at speeds much faster than playback speed. The present application can webcast at speed faster than playback speeds by caching or storing all of the audio tracks or video clips in a webcast, both on the receiving component and on relay servers, and decoupling the playing process from the receiving process. Decoupling the playing and/or transmitting processes from the receiving process eliminates the need for the webcast buffering used in current webcasting technology. The present application also enables files to be webcast in their original encoded audio or video format, without any degradation and with all information contained in their tags. By webcasting in the original encoded format, the application enables files to be “downloaded” directly from the webcast receiver's cache or storage device.

Eliminating the need for a continuous connection between the receiving component and the webcast server gives the present application a further advantage over current webcasting technology in mobile applications, where signal strength, and therefore effective bandwidth, varies considerably and even vanishes from time to time. By caching an entire webcast playlist, it frees listeners (and viewers) from the need to be continuously connected while listening. The present application provides the same advantages over “on-demand” transmission of playlists.

The present application achieves the further advantages of enabling a receiving component to receive, upon connection, the entirety of a webcast playlist, beginning with the first track or clip or any other desired track, and enabling the user of the receiving component to skip to the next track/clip as soon as it is available, and to replay any part of a webcast that has already been received.

Other features and advantages of the present application will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 shows schematically an embodiment of a webcasting apparatus.

FIG. 2 shows an embodiment of webcasting process.

FIG. 3 shows schematically an embodiment of a sequence of segments and headers transmitted in a webcast.

FIGS. 4-7 show different states of an embodiment of a user interface for a webcast receiver.

Wherever possible, the same reference numbers will be used throughout the drawings to refer to the same or like parts.

### DETAILED DESCRIPTION OF THE EXEMPLARY EMBODIMENTS

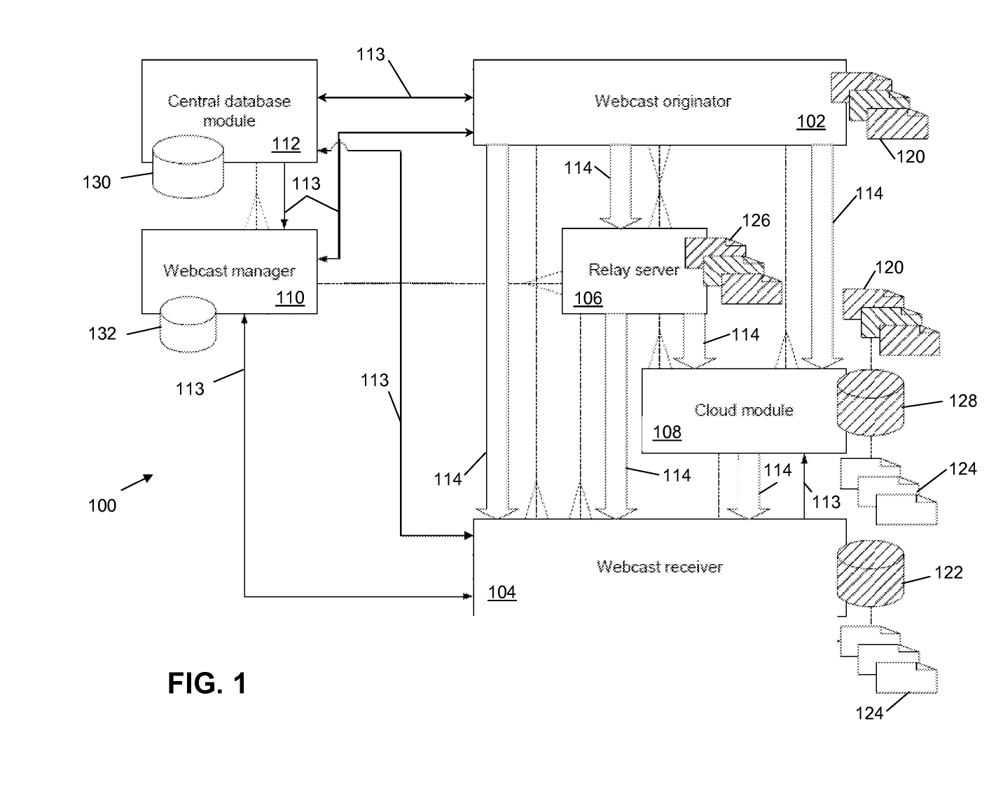

FIG. 1 shows an exemplary embodiment of a webcasting apparatus. The webcasting apparatus 100 can include up to six types of components: one or more webcast originators 102; one or more webcast receivers 104; zero or more relay servers 106; zero or more cloud modules 108; one or more webcast managers 110; and a central database module 112.

FIG. 1 shows the components, the data stores (e.g., caches or databases) associated with the components, and representative flows of message data 113 and webcast data 114 between components. The branched dotted lines indicate one-to-many and many-to-many relationships between components, e.g., one webcast manager 110 to many relay servers 106 or many webcast originators 102 to many relay servers 106. Unbranched dotted lines indicate one-to-one relationships, e.g., one cloud module 108 to one webcast receiver 104. In other words, the relationships and numbers of components in a webcasting apparatus 100 may differ from what is shown in FIG. 1. As shown in FIG. 1, a webcast 114 may proceed from a webcast originator 102 to a webcast receiver 104 either directly or via a relay server 106 and/or a cloud module 108.

The webcast originator 102, which may be controlled by a human webcaster, functions as a webcast server to one or more webcast clients (which may be webcast receivers 104, relay servers 106 and/or cloud modules 108) that initiate a connection with the webcast originator 102. The webcast originator 102 transmits the contents of a webcast playlist to the webcast clients. A webcast originator 102 may also initiate a connection to a relay server 106. In one exemplary embodiment, the webcast originator 102 can include one or more encrypted track files 120.

The webcast receiver 104, controlled by a human listener or user, initiates a connection to a webcasting component or server (which may be a webcast originator 102, relay server 106 and/or cloud module 108), to receive the contents of a webcast playlist. The webcast receiver 104 can also play the received contents for the human listener or user. In one exemplary embodiment, the webcast receiver 104 can include a cache of tracks 122 that includes one or more unencrypted track files 124.

The relay server 106 may be connected to one or more webcasting components or servers (which may be webcast originators 102 and/or other relay servers 106), which provide the relay server 106 with the contents of a webcast playlist. The relay server 106 may transmit the webcast playlist contents to one or more webcast clients or receiving components (which may be web cast receivers 104, other relay servers 106 and/or cloud modules 108) that initiate a connection with the relay server 106. In one exemplary embodiment, the relay server 106 can include one or more cached encrypted track files 126.

The cloud module 108, residing in an environment with network connectivity and access to local storage (e.g., as on a server farm), may be used in conjunction with a webcast receiver 104 to afford the user of the webcast receiver 104 access to received tracks and purchased tracks/clips that are stored on the network from any playing device or component (e.g., a webcast receiver 104 on a portable device) that is connected, wirelessly or otherwise, to the network. The cloud module 108 can have player functionality similar to that of a webcast receiver 104. Specifically, the cloud module 108 can stream tracks to a playing device or component and execute playing commands (e.g., pause, play, skip, fast forward, rewind) that the cloud module 108 receives from the playing device or component. In one embodiment, the cloud module 108 can eliminate the user's need to upload purchased tracks to the network, which may be a tedious and time-consuming process, as the upload speeds provided by Internet subscriptions are often much slower than their download speeds. In one exemplary embodiment, the cloud module 108 can include a cache of tracks and/or headers 128 that includes one or more encrypted track files 120 and one or more unencrypted track files 124.

The webcast manager 110 can: (1) handle requests from webcast clients or receiving components for connection to webcasts; (2) keep track of available relay servers 106 and assign them to webcast originators 102, webcast receivers 104 and other relay servers 106 requesting connection to transmitting relay servers 106; (3) manage the termination of webcasts; and (4) manage any purchases of tracks (as described below) by users of webcast receivers 104. All of the functions of the webcast manager 110 can be performed using a local database. A webcast manager 110 can communicate with the originator of a webcast to keep its webcaster informed of the webcast's status, and may delegate other webcast managers 110 from time to time to handle the management of webcasts, such as when the number of webcasts or the volume of message traffic increases for the webcast manager 110. In one exemplary embodiment, the webcast manager 110 can include a database 130 referencing webcasts, webcast managers and tracks 130.

The central database module 112 can keep track of available webcast managers 110 and assign them to webcasts, which are registered in the central database module 112 by webcast originators 102. All of the assignment and delegation functions of the central database module 112 can be performed using resource management and load balancing techniques. In one exemplary embodiment, the central database module 112 can include a database 132 referencing relay servers and webcast tracks.

Each of these component types for the webcasting apparatus 100 may be implemented as software, a computer program or a component of a computer program on any suitable computing device having a microprocessor, memory device and a network connection (either wired or wireless). Some examples of computing devices can include handheld computers (e.g., smart phone or portable media players), tablet computers, laptop computers or desktop computers. One or more of the components of the webcast apparatus 100 can be stored and executed on a single computing device. In addition, to the extent that components of the webcast apparatus are stored on separate or different computing devices, the separate or different computing devices can be connected by a network, e.g., the Internet.

Webcasting may be performed directly from webcast originators 102 to webcast receivers 104, or from webcast originators 102 through relay servers 106 and/or cloud modules 108 to webcast receivers 104.

In one embodiment, connections between the components of the webcasting apparatus 100 can be implemented using the technology of (stream) sockets, which ensures that streamed data is completely received in the order transmitted.

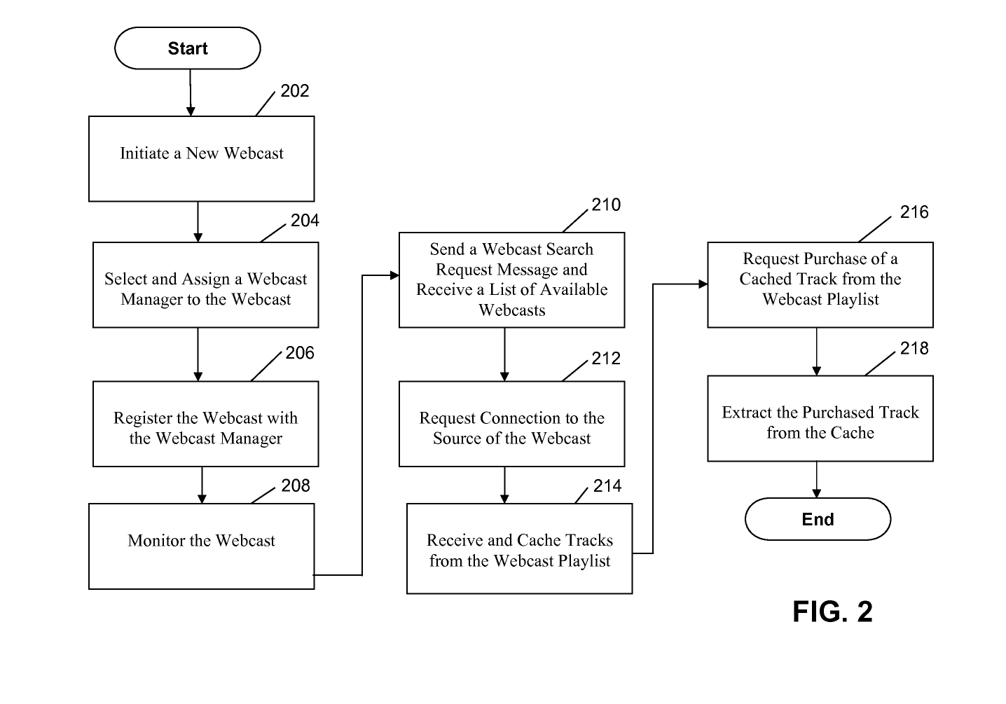

FIG. 2 shows an exemplary embodiment of a webcasting process using the webcasting apparatus 100. The process begins by a webcast originator 102 initiating a new webcast (step 202) by sending the central database module 112 a message containing metadata about the webcast and the tracks included in the playlist. The central database module 112 can select a webcast manager 110 and assign the webcast manager 110 to the webcast (step 204). The central database module 112 can return a message to the webcast originator 102 indicating the address of the webcast manager 110. In one embodiment, the message to the webcast originator 102 from the central database module 112 can update any applicable metadata about the tracks in the playlist.

The central database module 112 or the webcast originator 102 can register the webcast with the webcast manager 110 (step 206) by sending a message to the webcast manager 110 containing metadata about the webcast and (updated) metadata about the tracks. The webcast originator 102 can monitor the webcast (step 208) by receiving updates from the webcast manager 110, either periodically or in response to a request from the webcast originator 102, on the status of the webcast (e.g., number of connected listeners, tracks purchased, etc.).

A webcast receiver 104 can send a search request message to the central database module 112 specifying search criteria (e.g., title, music genres, etc.) for webcasts and receive from the central database module 112 a list of currently available webcasts (step 210), including the address of the webcast manager 110 for each webcast. In one embodiment, the list can be a randomly chosen subset of all currently available webcasts matching the search criteria. In another embodiment, if no search criteria is provided, a list can be provided that is a randomly chosen subset of all currently available webcasts. Upon the user's selection of a webcast from the list, the webcast receiver 104 sends the webcast manager 110 of the selected webcast a message requesting connection to the source of the webcast, which may be a relay server 106 or the webcast originator 102 (step 212). The webcast manager 110 returns the address of the webcast source to the webcast receiver 104, which then connects to the webcast source and receives and caches or stores the tracks contained in the webcast playlist (step 214). In another embodiment, if the webcast receiver 104 has an associated cloud module 108, a connection can be made between the webcast source and the cloud module 108 and then a connection can be made between the cloud module 108 and the webcast receiver 104, if a connection does not already exist between the cloud module 108 and the webcast receiver 104. The webcast source can then transmit the tracks contained in the webcast playlist to the cloud module 108, which caches or stores the tracks and transmits the tracks to the webcast receiver 104 (which can also cache or store the tracks).

The webcast receiver 104, upon the user's request to purchase a track or tracks contained in its cache, sends a message requesting purchase of the track(s) to the webcast manager 110 (step 216), which returns a message authorizing the purchase. The messages between the webcast receiver and the webcast manager 110 may contain codes for payment, authentication and/or authorization in accordance with established methods of electronic commerce. The webcast manager 110 can collect payment from the user and may allocate portions of that payment to the copyright owner of the track and/or the human webcaster, among other possible parties. Upon receiving the authorization message from the webcast manager 110, the webcast receiver 104 extracts the purchased track(s) from its cache (step 218), producing an unencrypted file (or files) which may be copied or played by the user of the webcast receiver 104. If the webcast receiver 104 has an associated cloud module 108, the cloud module 108 also extracts the purchased track(s) from its cache, producing a file or files (encrypted and/or unencrypted) which may be streamed to appropriate receiving components or otherwise made available to the user of the webcast receiver 104. In one embodiment, the webcast receiver 104 or the webcast manager 110 may need to connect to and communicate with the cloud module 108 in order to complete the extraction of purchased tracks. The webcast manager 110 registers the purchase and makes information regarding the purchase available to the webcast originator 102.

As used herein, the term “webcast server” can refer to any component that transmits a webcast 114, i.e., a webcast originator 102, a cloud module 108, or a relay server 106; the term “receiving component” or “webcast client” can refer to any component that receives a webcast 114, i.e., a webcast receiver 104, a cloud module 108, or a relay server 106; and any mention of a “track” (or similarly a “track file”) refers to a video clip as well as an audio track.

A webcast server has access to the complete set of tracks in a webcast playlist, and transmits those tracks, in order, to all connected receiving components that are to receive that webcast. The webcast server can transmit the tracks to the receiving components using individual streams or sockets that connect the webcast server to each receiving component. Rather than transmit a whole track at a time, the webcast server can divide the tracks into predetermined segments (which may be of equal length) and transmit each track, in order, a segment at a time, to the receiving component. Each segment can include a header identifying the track and the segment (for example, by the segment's number in the track's sequence of segments, and by the track's number in the webcast playlist). Headers may also contain other information to be conveyed to the receiving component. If more than one receiving component is connected to a webcast server, the webcast server can cycle through the receiving components and send each receiving component a segment before starting the process again to send the next segment.

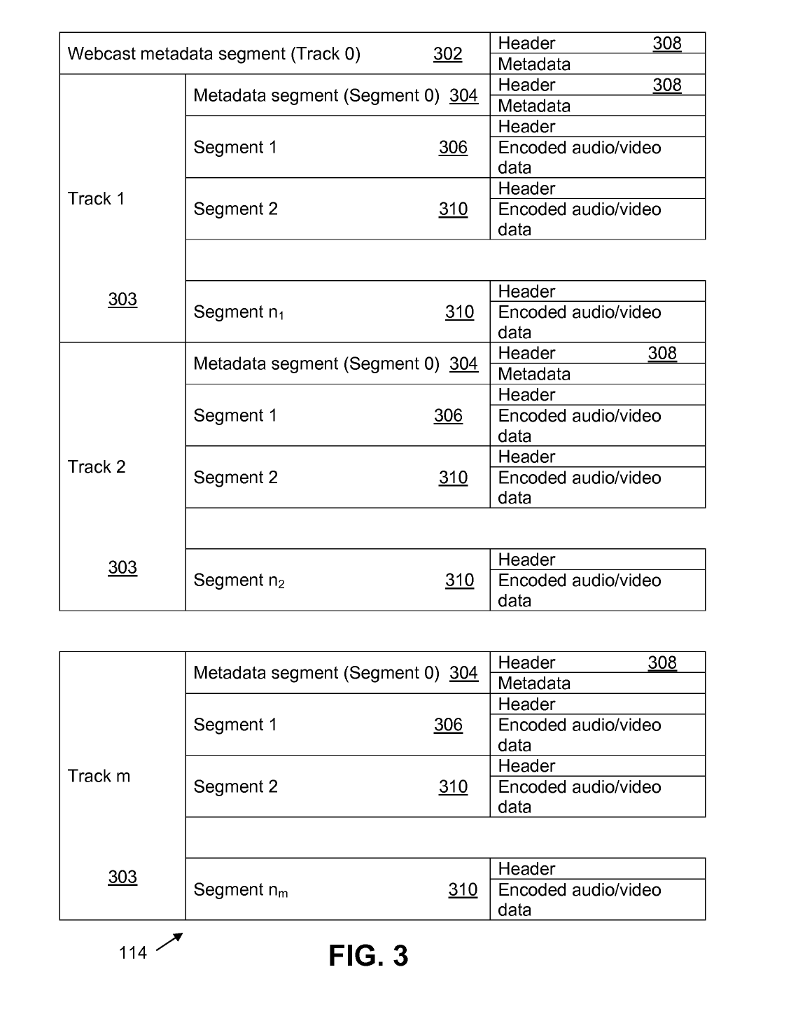

FIG. 3 shows a sequence of segments and headers transmitted in a webcast. When a receiving component is first connected to a webcast server, the webcast server transmits the first segment 306 of the first track 303 in the playlist. In another embodiment, the webcast server can transmit any other desired track 303, as determined by the receiving component. Metadata about the track 303 about to be transmitted may be transmitted, as a metadata segment 304, before the track's first actual segment 306 is transmitted and a similar metadata segment 302 containing metadata about the webcast playlist as a whole may be transmitted, at the beginning of the transmission. A metadata segment 302, 304 may contain a header 308 identifying its corresponding track 303 or webcast as well as marking the segment as a metadata segment (e.g., a track's metadata segment may have segment number 0 and the playlist's metadata segment may have track number 0). Once a track's first segment 306 has been transmitted, the remaining segments 310 are subsequently transmitted, in order. Each succeeding track 303 is then transmitted in a similar manner until the entire webcast playlist has been transmitted. In one embodiment, if the transmission to a particular receiving component began with a track other than the first one, the playlist's last track can be followed by the first track.

A receiving component caches or stores tracks locally (i.e., in memory and/or in external storage such as a hard disk) as the tracks are received, assembling each track, segment by segment, until the track is complete. Once the entire playlist of tracks has been received, the receiving component may be disconnected from the webcast server or transmitting component. Received tracks may be stored as distinct or individual files (e.g., by a relay server 106), or the received tracks may be combined in a single file. In the webcast receiver 104 or a cloud module 108, received tracks may be stored in a cache or file having a predetermined size that is configured as a “circular file.” In a “circular file,” the newest data received can overwrite the oldest data stored once the file or cache is filled. Caching or storing of received tracks enables a relay server 106 to retransmit a webcast's entire set of tracks to further receiving components in the same manner described above. In addition, caching or storing of received tracks enables a webcast receiver 104 (or a cloud module 108) to play any received track (whether from the current webcast or from a previously received webcast) that is entirely contained in the cache. In one embodiment, the cache of a cloud module 108 can replicate the cache of its corresponding webcast receiver 104. In other words, the caches of the webcast receiver 104 and its corresponding cloud module 108 can be of identical size and configuration (i.e., linear or circular) and maintain the same contents.

In one embodiment, rather than have a webcast server “pump out” the successive segments of a track in order in a continuous thread, which would necessitate waiting for any given segment to be completely transmitted to all connected receiving components before transmitting the next segment, a message queue that executes in a separate thread can be set up for the transmission of segments. As each receiving component connects, the first segment of each webcast to be transmitted to that receiving component (e.g., a metadata segment containing metadata about the webcast playlist) can be transmitted. Then, as soon as each segment of a webcast has been completely transmitted to a receiving component, a message (a send message) that can trigger the transmission of the next segment of the same webcast to that receiving component is appended to the message queue by the receiving component. The transmission of segments triggered by send messages can be implemented in a separate thread of execution, which thread can receive and append to the message queue a send message requesting the next segment (of the same webcast) to be transmitted to a receiving component.

The next segment to be transmitted to the receiving component can include several different types of segments. In one embodiment, the next segment can be the first segment of the first track (if no track segments have been transmitted). In a second embodiment, the next segment can be the first segment of the next track (if at the end of the track) or a metadata segment with metadata about the next track followed by the track's actual first segment. In a third embodiment, the next segment can be the first segment of the corresponding track (if the segment just transmitted is a metadata segment). In a fourth embodiment, the next segment can be a message or segment header indicating the playlist has been transmitted (if the complete playlist has been transmitted), so that the receiving component may terminate the connection upon receiving the complete segment. In a fifth embodiment, the next segment can be the next segment of the track currently being transmitted to the receiving component.

In one embodiment involving a relay server 106 to transmit to the receiving components, the next segment to be transmitted to the receiving component may not have been received by the relay server 106 by the time the corresponding send message is generated by the receiving components. In that case, provision can be made (e.g., setting a flag) to configure the relay server 106 to send the next segment upon receipt of the next segment by the relay server 106.

Using a message queue and separate threads of execution to facilitate the simultaneous transmission of the streams to the receiving components, the segments transmitted to various connected receiving components may be transmitted smoothly and asynchronously, with minimal delay. Such asynchronous transmission may be used if the segments have to be encrypted or otherwise processed as the segments are transmitted which may result in “bottlenecks” or disparities in processing time for different segments. In addition, the length of the message queue may be used to detect bandwidth saturation, and the processing of messages in the message queue may be “paced” or delayed from time to time to maintain a predetermined limit on bandwidth usage.

In one embodiment, a receiving component, upon successfully receiving the last segment of a track, can transmit a message to the webcast source (e.g., a webcast originator 102 or a relay server 106) indicating that the track has been completely received.

Referring back to FIGS. 1 and 2, a webcast originator 102 can initiate a webcast by registering the webcast with the central database module 112. The central database module can store information about the webcast to enable the users of the webcast receivers 104 to search for and retrieve the webcast by searching for particular tracks or other aspects of the webcast, such as title or genres. The central database module 112 can also assign a webcast manager 110 to manage the webcast. Upon receiving a message from the central database module 112 indicating that the webcast has been successfully registered, which message may also identify the assigned webcast manager 110 and/or a relay server 106 assigned to the webcast by the webcast manager 110, the webcast originator 102 may either (1) set up a socket to listen for new connections from receiving components or (2) connect to a relay server 106 identified by the webcast manager 110 and transmit to the relay server 106 the contents of the webcast playlist. Other than the optional transmission of the webcast playlist to the relay server 106, no actual transmission of the webcast playlist occurs until a receiving component connects to the webcast server (i.e., the webcast originator 102 or a relay server 106). Once a receiving component connects to the webcast server, the webcast server transmits the entire contents of the webcast playlist (segment by segment). The receiving component may transmit a message to the webcast server indicating that the receiving component has completely received the webcast playlist and then disconnect from the webcast server.

In one embodiment, a webcast server (i.e., a relay server 106 or a webcast originator 102) may be assigned a new receiving relay server 106 by the webcast manager 110 when the total capacity of the webcast originator 102 and/or any already connected relay servers 106 is determined to be fully engaged or used. The webcast server can then connect to the newly assigned receiving relay server 106 and transmit to the receiving relay server 106 the contents of at least one of its webcast playlists. Thereafter, receiving components connecting to the webcast(s) in question can connect to the newly assigned receiving relay server 106. The receiving relay server 106 may be similarly assigned a second relay server 106, if needed, and the process may be repeated indefinitely in response to demand for connection bandwidth from receiving components.

In addition to initiating webcasts, a webcast originator 102 may also terminate a webcast. A webcast originator 102 initiates the termination process by (1) sending a message to the central database module 112 to remove the webcast and (2) sending the webcast manager 110 a message to terminate the webcast. The webcast manager 110 can then send termination messages to all relay servers 106 associated with the webcast. In addition, a webcast server (whether a webcast originator 102 or a relay server 106) may terminate a webcast by (1) ceasing to accept new connections to receiving components, (2) transmitting the remainder of the playlist contents to existing connected receiving components (unless overridden by the webcast originator 102) and (3) disconnecting from each of the receiving components, optionally after receiving a message from each receiving component indicating that the applicable webcast has been completely received. The relay server 106 may delete all cached track files for a terminated webcast when all receiving components have been disconnected.

A relay server 106 may be removed from a webcast, when the webcast manager 110 determines that the relay server 106 is no longer needed, in which case the relay server 106 follows the procedure for terminating a webcast. If a webcast is being transmitted by several relay servers 106 and demand for connection bandwidth from receiving components diminishes, the webcast manager 110 can limit new connections (to receiving components) to a limited number of those relay servers 106 so that the remaining relay servers 106 may be removed from the webcast.

The user of a webcast receiver 104 can search for webcasts by querying the central database module 112 and receiving a list of search results containing information about currently registered webcasts that meet any specified search criteria. The search results can also identify the webcast manager 110 for each webcast returned. The webcast receiver 104 can connect to any webcast identified in the list of search results by sending a message to the webcast manager 110 for the webcast, which returns the address of a webcast server (either the webcast originator 102 or a relay server 106) transmitting the webcast. The webcast receiver 104 then can connect to the webcast server.

Once a webcast receiver 104 has received an entire track, or a sufficient portion thereof, the webcast receiver 104 may play the track in the normal manner of playing encoded tracks. Upon first connecting to a webcast server, the webcast receiver 104 may need to receive the entire first track before it can play the first track, but thereafter successive tracks may be played without gaps between them if the transmission speed between the webcast server and webcast receiver 104 is sufficiently faster than playback speed of the webcast receiver 104. As soon as the webcast receiver 104 has finished playing each track in the order of the webcast playlist, the webcast receiver 104 can play the next track. Each successive track in the sequence can be referred to as the current track. Upon reaching the end of a webcast playlist, the webcast receiver 104 can attempt to connect to other webcasts identified in its list of search results, until the webcast receiver 104 either successfully connects to another webcast or exhausts the list. If the list is exhausted, the webcast receiver 104 can conduct a new webcast search with the same search criteria and attempt to connect to webcasts, including newly registered webcasts, identified in the returned list of search results in the same manner. In addition, the webcast receiver 104 can prompt the user to conduct a new webcast search.

The caching of received tracks enables a webcast receiver 104 that has been turned off, upon being activated or turned on, to automatically “pick up where it left off,” i.e., to resume playing the track that was the current track at the time the webcast receiver 104 was most recently shut down (or, alternatively, the following track or any other cached track) without needing to connect to a webcast server.

The user of a webcast receiver 104 may (re)play any part of any received track that is still in the cache, and may skip ahead to any track that has been completely received. The user may do so by selecting a track from a displayed list of tracks contained in the webcast receiver's cache. In one embodiment, the list of tracks can show the current track as selected, but can permit the user to select other tracks. If the list of tracks does not display tracks that have not been played, which may occur at the user's option, a button or similar control is provided to skip to the next track. When a track other than the current track is selected, a button or similar control can be provided for the user to play the selected track (or a portion or sample thereof). If the user presses this button (or similarly activates the control), the current track, if playing, is interrupted and the selected track (or sample thereof) is played. If the user takes no action within a predetermined time after selecting and/or playing a non-current track, the current track can be automatically selected by the webcast receiver 104 and resumed.

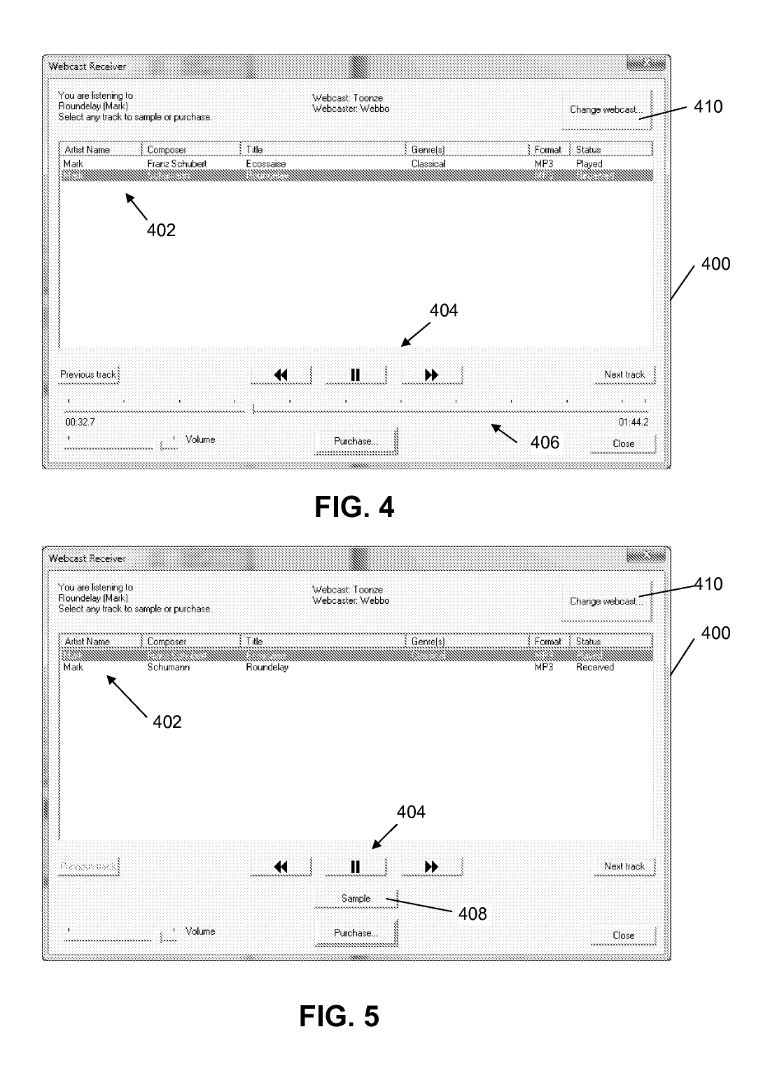

FIGS. 4-7 show successive states of a user interface for the webcast receiver 104. The user interface 400 for the webcast receiver 104 can display on the computing device executing the webcast receiver 104 a list of tracks 402, playback buttons (reverse skip, play/pause, forward skip) 404, and a track slider 406 showing the current position in the track that is currently playing. The track slider 406 is displayed when the track currently selected in the list is currently playing.

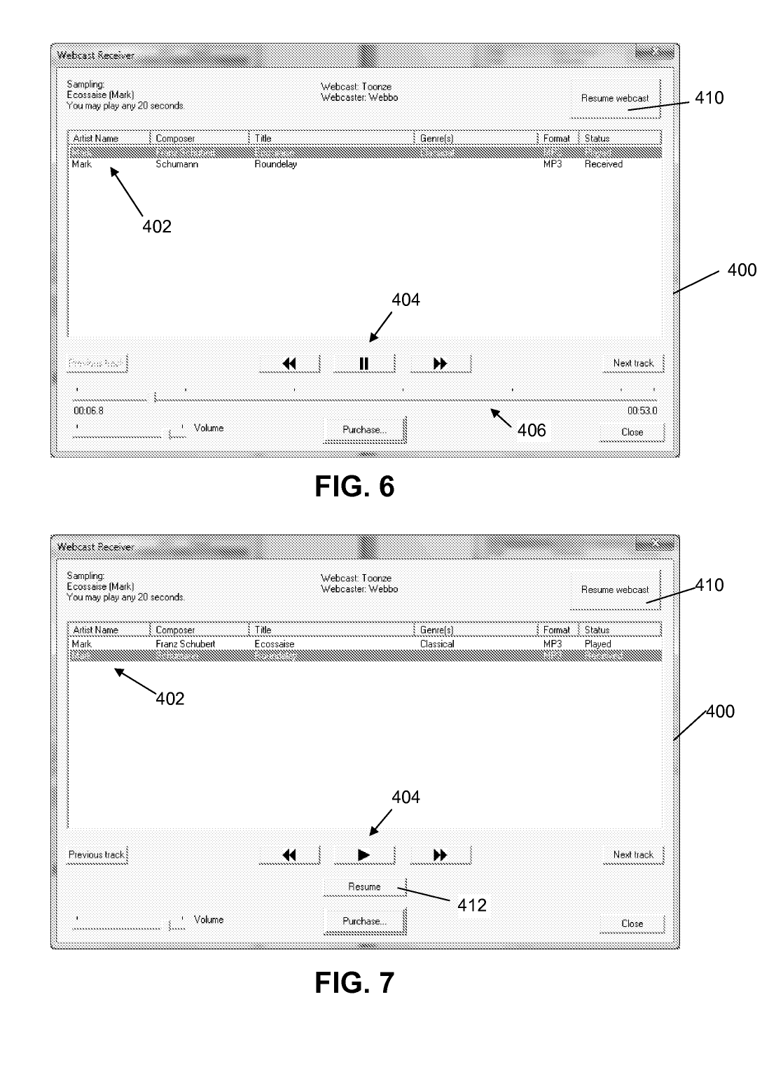

In FIG. 4, the current track is selected in the list of tracks 402 and is playing as shown by the track slider 406. In FIG. 5, the user has selected the first track in the list of tracks 402, causing a “Sample” button 408 to be shown in place of the track slider 406 for the current track (which can still be playing). In FIG. 6, the user has pressed the “Sample” button 408, directing a 20-second sample of the selected first track to be played. The track slider 406 shows the current play position in the first track. The button 410 marked “Change webcast” in FIGS. 4 and 5 is now marked “Resume Webcast” in FIG. 6. If the user presses the button 410 marked “Resume Webcast,” the current track resumes playing at the point where the user pressed the “Sample” button in FIG. 5 and the user interface 400 resumes the appearance of FIG. 4. The user may achieve the same result by selecting the current track in the list (FIG. 7) and pressing the “Resume” button 412 that appears in place of the track slider 406.

In FIG. 7, the “play” state of the play/pause button indicates either the user has paused the playing track or the end of the 20-second sample has been reached. In this state, the current track may resume playing and the user interface 400 may resume the appearance of FIG. 4, if the user takes no action within a predetermined interval of time.

In another embodiment, notwithstanding the use of error-preventing and error-correcting protocols, receiving components may detect errors in transmitted segments. If an error occurs in a transmitted segment, a receiving component may send a webcast server a “negative acknowledgment” that a particular segment has not been correctly received. Upon receiving the “negative acknowledgment”, the webcast server re-transmits the incorrectly received segment, followed by all subsequent segments in the usual order of the webcast. The receiving component ignores all other received segments until the first re-transmitted segment is received.

A user using the webcast receiver 104 may disconnect from the current webcast, whether to connect to a different webcast or to shut down the webcast receiver 104. When the user disconnects from the current webcast, the user may be given the options whether to remain connected long enough to receive (into the cache) any unreceived tracks in the webcast, and/or to preserve any tracks that have been received (either played or unplayed).

In applications where a sequence of tracks, clips or similar portions of a broadcast stream is broadcast continuously, the present application can be used to cache (at the receiving component) the finite sequence of such tracks that is broadcast repeatedly to remove the need to transmit the tracks more than once to the receiving component. The caching of tracks can also be used where only particular tracks are repeated. In one embodiment, the caching of frequently repeated tracks can be done separate from or outside of the “circular file,” if used, at the receiving component. In another embodiment, where it is known at a webcast source that a particular receiving component has a complete (cached or uncached) copy of a particular track, a short header identifying the track can be transmitted in place of the track itself, and optionally in place of the track's metadata segment, wherein the transmitted header may or may not be identical.

In one embodiment, where it is unknown at a webcast source whether a particular receiving component has complete copies of any or all track files in a webcast playlist, the webcast source can transmit (when the receiving component first connects) a message containing headers for all tracks in the playlist. The receiving component can respond with a message indicating which track files are already in the receiving component's possession. This exchange of messages can be used in “podcasting,” where a user may subscribe to a selection of “feeds” having various content files, each of which may be updated from time to time. The headers transmitted by the webcast source can contain a timestamp for each content file, which the receiving device can compare with the timestamp of the corresponding file (if any) in the receiving device's possession in order to determine whether an updated file is to be transmitted.

In another embodiment, if a webcast source begins transmitting a track (or the track's metadata segment) to a receiving component that already has a copy of the track, the receiving component may transmit to the webcast source a message indicating the receiving component has a copy of the track. Upon receiving the message from the receiving component, the webcast source can cease transmitting segments of that track and proceed to the next track.

In mobile applications, a webcast receiver 104 may lose a connection with the webcast source before the webcast receiver 104 has received all of the tracks in a webcast playlist. In that case, when connectivity is reestablished (as determined by monitoring signal strength), the webcast receiver 104 can send the webcast manager 110 a message requesting the tracks (and/or track segments) that the webcast receiver 104 has not completely received. The webcast manager 110 then sends the webcast receiver 104 a message indicating the address of an available webcast source, to which the webcast receiver 104 connects and receives the remaining segments and/or tracks. If the connection is lost again, the process is repeated until the entire playlist contents have been received.

Encryption may be used to prevent unauthorized use of webcasts and their component tracks, especially when relay servers 106 are hosted by third parties. When transmitting a webcast in encrypted form, the webcast originator 102 can create encrypted copies of the webcast's tracks and/or segments, and destroy those copies when the webcast is terminated. A webcast receiver 104 may decrypt the tracks or segments either in the course of receiving them or in the course of playing them.

The original track files used in such an encrypted webcast may themselves be already encrypted, as in the content distribution method and apparatus disclosed in U.S. patent application Ser. No. 12/381,401, which application is hereby incorporated by reference in its entirety. Further encrypting the files for webcasting can prevent access to the files in their original encrypted form as handled by originators and webcasters at the relay servers 106. In this case, the second encryption (for webcasting) may be performed on receiving such encrypted files, and the encrypted files may be cached in some variant of their original encrypted form. In one embodiment, established methods of shrouding (or encryption) may be used to prevent direct access to the files in their original encrypted form. Decryption of the original stage of encryption, in this case, can be performed when playing the tracks.

Two-stage encryption can be used where users of webcast receivers 104 are enabled to “download” tracks, i.e., decrypt track files from the webcast receiver's cache into their original encoded (unencrypted) form, upon payment of a fee. A user can begin the “download” of a track by selecting the track from a displayed list, where the opportunity to play the track (or a portion of the track) is provided as described above. The various operations involved in “downloading” a track (e.g., authentication, payment by the listener, crediting and/or distribution of funds to appropriate parties, including the webcaster) can be managed by the webcast manager 110 of the webcast that transmitted the track.

If a user or listener using a webcast receiver 104 specifically opts to hear (or “download”) a particular track, that track may be transmitted by the webcast server before the remaining tracks in a playlist, and received and played first by the webcast receiver 104, followed (unless the listener chooses otherwise) by the remaining tracks.

In contrast with existing webcasting technology, the present application does away with the concept of a currently playing track for all listeners. Nonetheless, it may be desirable to transmit to a set of webcast receivers 104 so that they play a webcast's tracks more or less synchronously, as when those listening are engaging in a live “chat” about the webcast. This may be achieved by (1) “artificially” setting a particular track as the current one at the beginning of a webcast; (2) as long as the webcast proceeds, setting the next track as the current one when the current track's duration has elapsed, and (3) when any webcast receiver 104 connects, transmitting and playing the current track first. These functions can be performed by the webcast manager 110 managing the webcast.

The pre-recorded tracks in a webcast may be combined with “voice-over” input by a human webcaster (in the manner of a radio disk jockey) while preserving the receiver's ability to extract the tracks in their original form. The “voice over” may be achieved by first providing tools (mixing tools) in the webcast originator 102 for the webcaster to control mixing of live (voice) input and pre-recorded sound in the manner of well-known mixing boards used by disk jockeys that can include tools to produce cross-fading and transition effects. Next, the webcaster can be enabled to operate the tools in the normal manner of operating a mixing board for “voice-over” mixing, while recording the webcaster's “voice-over” input and to operate the tools in connection with playing pre-recorded tracks and encoding all parameters of the webcaster's operation of the tools (mixing parameters) that may be needed to reproduce the audio output produced by the mixing process (e.g., time position of a “voice-over” segment relative to a track with which the “voice-over” segment is synchronized, volume settings, transition effect parameters, cross-fade curves). Each “voice-over” audio segment, which may include discrete portions separated in time, in the webcast transmission can be included as a voice-over track (possibly encoded in a compressed audio format and segmented in the manner of a pre-recorded track) preceding the first pre-recorded track with which the voice-over track is synchronized. The voice-over track can be preceded by a metadata segment (mixing segment) containing the associated set of mixing parameters. Finally, systems can be provided in the webcast receiver 104 to reproduce the audio output (mixing output) produced by the mixing process performed in the webcast originator 102 and to combine the voice-over segments and their associated pre-recorded tracks by interpreting the data in the associated mixing segments so as to reproduce the mixing output in the course of playing the webcast.

The pre-recorded tracks can be preserved in their original form in the webcast receiver's cache, while being combined with the contents of voice-over tracks so as to reproduce the mixing output in the course of playing the webcast. The mixing output may also be reproduced in the course of playing (samples of) tracks other than the current track.

Moreover, the webcaster may expedite the mixing process by skipping over those portions of pre-recorded tracks that are to remain unmixed to a point in the pre-recorded track near the end of a track or to a transition between tracks, and may also re-input portions of the mixing process if desired.

Video content may be handled similar to audio content. In addition to being mixed, in the course of playing a webcast, with “voice over” material in a manner similar to audio tracks, video clips may be mixed with picture-in-picture, split-screen or other content (as in the form of layers, annotations, etc.) that may be added by the webcaster, while preserving the receiver's ability to extract the clips in their original form. For video, the mixing tools enable a webcaster to implement such video effects and the mixing process records their mixing parameters, which are transmitted as mixing segments so that the video (and audio) output produced by the mixing process may be reproduced by the webcast receiver.

In an exemplary embodiment, the webcasting method and apparatus can be compatible with all digital (audio and video) file formats, whether now existing or to be invented or introduced in the future. These formats include raw files, container formats (e.g., 3GPP, 3GPP2, ADIF, ADTS, Advanced Systems Format (AFS), Au, Audio Video Interleave (AVI), CAF, Extensible Music Format (XMF), Flash Video (FLV, F4V), Interchange File Format (IFF), Matroska Multimedia Container (MKV, MK3D, MKA, MKS), Microsoft Digital Video Recording (DVR-MS), MJ2/JPEG2000, ogg, Resource Interchange File Format (RIFF)), compressed audio and video formats (e.g., G.729, ACT, Adaptive Multi-Rate (AMR), Adaptive Multi-Rate Wideband (AMR-WB), Advanced Audio Coding (AAC), Apple Lossless Audio Codec (ALAC), Adaptive Transform Acoustic Coding (ATRAC), Audio Interchange File Format (AIFF), Digital Speech Standard (DSS), dvf, Free Lossless Audio Codec (FLAC), GSM-FR, General eXchange Format (GXF), iKLAX, IVS, mmf, MPEG program stream (MPEG-PS), MPEG transport stream (TS), MP1, MP2, MP3, MP4, M4P, MPC (Musepack), msv, Material eXchange Format (MXF), mxp4, NUT, ratDVD, RealAudio (ra & rm), SVI, The True Audio (TTA), Vorbis, vox, QuickTime File Format (QTFF), VOB (Video Object), Windows Media Audio (WMA)), and uncompressed audio formats (e.g., pulse code modulation (PCM), WAV). Further, decoupling the playing process from the receiving process facilitates handling variable-bitrate formats and formats based on non-linear sampling.

In another exemplary embodiment, the caching or storing of the tracks or segments in a memory device can result in the tracks or segments being stored for an indefinite period of time. In contrast, if the tracks or segments were buffered or stored in a buffer, the tracks or segments could not be kept indefinitely and would be erased or overwritten in a short period of time. In other words, as understood by one skilled in the art, the buffering of data in a memory device is for immediate use, after which the locations in which the data is stored may be erased or overwritten with other data. In contrast, the caching of data in a memory device is for an indefinite interval of time, so that the data may be used at some arbitrary time or times in the future. For example, the caching (rather than buffering) of the tracks in a playlist in a receiving component enables those tracks to be played or transmitted at some arbitrary time in the future and enables the decoupling of the receiving process from the playing or transmitting process.

Embodiments within the scope of the present application include program products having machine-readable media for carrying or having machine-executable instructions or data structures stored thereon. Machine-readable media can be any available non-transitory media that can be accessed by a general purpose or special purpose computer or other machine with a processor. By way of example, machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communication connection (either hardwired, wireless, or a combination of hardwired or wireless) to a machine, the machine properly views the connection as a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Although the figures herein may show a specific order of method steps, the order of the steps may differ from what is depicted. Also, two or more steps may be performed concurrently or with partial concurrence. Variations in step performance can depend on the software and hardware systems chosen and on designer choice. All such variations are within the scope of the application. Likewise, software implementations could be accomplished with standard programming techniques with rule based logic and other logic to accomplish the various connection steps, processing steps, comparison steps and decision steps.

While the exemplary embodiments illustrated in the figures and described herein are presently preferred, it should be understood that these embodiments are offered by way of example only. Other substitutions, modifications, changes and omissions may be made in the design, operating conditions and arrangement of the exemplary embodiments without departing from the scope of the present application. Accordingly, the present application is not limited to a particular embodiment, but extends to various modifications that nevertheless fall within the scope of the appended claims. It should also be understood that the phraseology and terminology employed herein is for the purpose of description only and should not be regarded as limiting.

It is important to note that the construction and arrangement of the present application as shown in the various exemplary embodiments is illustrative only. Only certain features and embodiments of the invention have been shown and described in the application and many modifications and changes may occur to those skilled in the art (e.g., variations in sizes, dimensions, structures, shapes and proportions of the various elements, values of parameters (e.g., ranges, sequences, enumerations, frequencies, durations, etc.), mounting arrangements, use of materials, orientations, data formats, implementation platforms, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, manufacture, and implementation for those of ordinary skill having the benefit of this disclosure, without undue experimentation.

What is claimed is:

1. A system comprising:
a webcast server, the webcast server comprising a microprocessor and a memory device, the memory device of the webcast server storing at least one playlist in an encoded format;
a webcast client connected to the webcast server over a computer network, the webcast client comprising a microprocessor and a memory device;
a webcast module being operable to facilitate the transmission of the at least one playlist from the webcast server to the webcast client without a change in the encoded format of the at least one playlist; and
the webcast client comprising a cache to store the entire at least one playlist.

2. The system of claim 1 further comprising at least one webcast manager, the at least one webcast manager being operable to enable connections between the webcast server and the webcast client to enable transmission of the at least one playlist from the webcast server to the webcast client.

3. The system of claim 2 further comprising a central database module, the central database module being operable to manage the at least one webcast manager and assign the at least one playlist from the webcast server to the at least one webcast manager.

4. The system of claim 1 wherein the webcast server comprises at least one of a webcast originator or a relay server.

5. The system of claim 4 wherein the relay server is connected to the webcast originator to receive the at least one playlist from the webcast originator.

6. The system of claim 1 wherein the webcast client comprises at least one a cloud module or a webcast receiver.

7. The system of claim 6 wherein the webcast receiver is connected to the at least one cloud module to receive the at least one playlist from the cloud module.

8. A webcasting method comprising:
storing a playlist for a webcast on a webcast server by a user;
selecting the playlist for download by a receiving component;
transmitting the playlist from the webcast server to the receiving component over a computer network without changing the encoded format of the playlist;
storing the entire transmitted playlist in a cache of the receiving component; and
playing the playlist from the cache on the receiving component for a user.

9. The webcasting method of claim 8 further comprising:
initiating the webcast with a central database module by sending a message from a webcast originator with the playlist to the central database module with information on the playlist and the webcast;
assigning a webcast manager to the webcast by the central database module; and
registering the webcast with the webcast manager by the central database module or the webcast originator.

10. The webcasting method of claim 9 further comprising monitoring the status of the webcast by the webcast originator by receiving a message from the webcast manager.

11. The webcasting apparatus of claim 9 wherein said storing a playlist for a webcast on a webcast server comprises
identifying by the webcast manager a relay server to receive the playlist; and
transmitting the playlist from the webcast originator to the relay server, the relay server storing the playlist for subsequent transmission to a receiving component.

12. The webcasting apparatus of claim 11 wherein said transmitting the playlist from the webcast server to the receiving component comprises:
receiving a request at the webcast manager from a receiving component for access to the webcast; and
providing the receiving component with an address for the relay server or the webcast originator.

13. The webcasting method of claim 8 wherein said transmitting the playlist from the webcast server to the receiving component comprises:
dividing the playlist into a plurality of tracks;
dividing each track of the plurality of tracks into a plurality of segments; and
sequentially transmitting each segment of the plurality of segments to the receiving component.

14. The webcasting method of claim 13 further comprising:
purchasing by a user of the receiving component a track of the plurality of tracks for purchase; and
extracting the purchased track from the cache of the receiving component and storing the purchased track in a separate memory location from the cache at the receiving component.

15. The webcasting method of claim 13 wherein said transmitting the playlist from the webcast server to the receiving component further comprises encrypting each segment of the plurality of segments before transmitting the segment.

16. The webcasting method of claim 8 further comprising:
transmitting a second playlist from the webcast server to the receiving component over a computer network without changing the encoded format of the second playlist; and
storing the entire transmitted second playlist in the cache of the receiving component.

17. The webcasting method of claim 16 wherein said storing the entire transmitted second playlist in the cache of the receiving component comprises overwriting at least a portion of the playlist stored in the cache.

18. The webcasting method of claim 8 wherein
said transmitting the playlist from the webcast server to the receiving component comprises transmitting the playlist from the webcast server to a cloud module; and
said storing the entire transmitted playlist in a cache of the receiving component comprises storing the entire transmitted playlist in a cache of the cloud module.

19. The webcasting method of claim 18 further comprises transmitting the playlist over a computer network from the cloud module to a webcast receiver operator by the user.
